(19) United States
(12) Patent Application Publication
(10) Pub. No.: US 2025/0005345 A1
(43) Pub. Date: Jan. 2, 2025

(54) COMPUTER-IMPLEMENTED METHOD FOR TRAINING A NEURAL NETWORK (NN) MODEL FOR NAME SCREENING BASED ON A SANCTION LIST OF FRAUD ENTITIES

(71) Applicant: Actimize LTD., Ra'anana (IL)

(72) Inventors: Prasad MHATRE, Pune (IN); Sumit Kumar, Pune (IN)

(21) Appl. No.: 18/215,174

(22) Filed: Jun. 28, 2023

(51) Int. Cl. G06N 3/08

(52) U.S. Cl. CPC G06N 3/08

(57) ABSTRACT

A computer-implemented method for training an NN model for name screening based on a sanction list of fraud entities includes (i) preparing labeled-data based on the sanction list of fraud entities; (ii) training the NN model based on the labeled data to calculate embeddings of each entity name in the labeled data for each two or three sub-networks of the NN model; (iii) forwarding the embeddings to a loss function to yield an indication as to necessity to adjust weights in the two or three sub-networks of the NN model; (iv) repeating operations (ii)-(iii) when the loss function indicated necessity to adjust weights in the two or three sub-networks of the NN model; and (v) storing the embeddings of each entity name in a database of embeddings. The sanction list of fraud entities is stored in a database of entities, and each entity has a name and other attributes.

### TECHNICAL FIELD

The present disclosure relates to the field of Neural Network (NN) models and more specifically, to training an NN model for name screening based on a sanction list of fraud entities.

### BACKGROUND

Labeled data is an integral feature of the Machine Learning (ML) models. Well-trained ML models provide accurate predictions which better assist to take decisions. Commonly, the training of an ML model requires a large amount of data to learn and then classify, but for example. in cases of signature match and face recognition, there are only a few shots for ground truth which is similar to the situation of scarcity of data as to fraudsters for training of fraud detection ML models.

Current systems face inaccuracies of the ML models predictions due to limited data of one or more classes for training of the ML models for classification. Consequently, the ML model is trained with few labels for each class, which means that there are only a few shots available to recognize or to classify the class during training.

Few-shots learning algorithms which learn from a few instances are implemented in signature match and face recognition which also suffer from scarcity of data. However, there is no technical solution which applies the few-shots learning algorithms on text, such as names and variations of the names.

Economic sanctions are part of a fight against financial crime for Anti Money Laundering (AML) regulators and other types of fraud. There are penalties imposed on financial institutions and organizations that are breaching sanctions and provide service to entities which are part of a sanction list. Sanction lists of fraud entities are published and include names and other details of sanctioned people, organizations, or governments.

However, each name in the sanction list of fraud entities appears only once in a certain spelling where in reality the name may have several variations of spellings which might make it difficult to identify by a simple comparison of name screening. Accordingly, there is a need for a technical solution to train a Neural Network (NN) model for name screening based on a sanction list of fraud entities.

### SUMMARY

There is thus provided, in accordance with some embodiments of the present disclosure, a computer-implemented method for training a Neural Network (NN) model for name screening based on a sanction list of fraud entities.

Furthermore, in accordance with some embodiments of the present disclosure, the computer-implemented method includes: (i) preparing labeled data based on the sanction list of fraud entities; (ii) training the NN model based on the labeled data to calculate embeddings of each entity name in the labeled data for each two or three sub-networks of the NN model; (iii) forwarding the embeddings to a loss function to yield an indication as to necessity to adjust weights in the two or three sub-networks of the NN model; (iv) repeating operations (ii)-(iii) when the loss function indicated necessity to adjust weights in the two or three sub-networks of the NN model; and (v) storing the embeddings of each entity name in a database of embeddings. The sanction list of fraud entities may be stored in a database of entities, and each entity in the database of entities has a name and other attributes.

Furthermore, in accordance with some embodiments of the present disclosure, the computer-implemented method further includes using the embedding of each entity name stored in the database of embeddings to operate name screening for a new entity by the trained NN model to provide a prediction score for the new entity.

Furthermore, in accordance with some embodiments of the present disclosure, the labeled data includes entities labeled as ‘anchor’ for a first sub-network of the NN model and entities labeled as at least one of: ‘positive’ and ‘negative’ for a second and third sub-network of the NN model.

Furthermore, in accordance with some embodiments of the present disclosure, when the NN model has two sub-networks the NN model training is based on combinations of entities labeled as ‘anchor’ and entities labeled as ‘negative’ or ‘positive’, and when the NN model has three sub-networks the NN model training is based on combinations of entities labeled as ‘anchor’, entities labeled as ‘negative’, and entities labeled as ‘positive’.

Furthermore, in accordance with some embodiments of the present disclosure, entities in the labeled data may be labeled as ‘anchor’ by collecting a first preconfigured percentage of the sanction list of fraud entities to yield a first sample and then operating a name screening model on the sanction list of fraud entities with an entity name from the first sample to mark generated hits as ‘anchor’. Entities in the labeled data may be labeled as ‘negative’ by removing a second sample of a second preconfigured percentage of the sanction list of fraud entities and then operating the name screening model on the sanction list of fraud entities with an entity name from the second sample to mark generated hits as ‘negative. Entities in the labeled data may be labeled as ‘positive’ by collecting a third preconfigured percentage of the sanction list of fraud entities to yield a third sample, running one or more algorithms on the third sample to generate variations of each entity name in the third sample and operating name screening on the sanction list of fraud entities with an entity name from the third sample to mark generated hits as ‘positive’.

Furthermore, in accordance with some embodiments of the present disclosure, the name screening model may be operated by providing the entity name and the sanction name to a matching engine, to yield a base hit score, and adjusting the base hit score based on other score factors.

Furthermore, in accordance with some embodiments of the present disclosure, the NN model may be a Siamese neural network.

Furthermore, in accordance with some embodiments of the present disclosure, the indication as to necessity to adjust weights in the two or three sub-networks of the NN model may be a similarity result of the loss function which is below a preconfigured threshold.

Furthermore, in accordance with some embodiments of the present disclosure, when the trained NN model provides a prediction score above a preconfigured threshold the computer-implemented method may further comprise blocking an account of the new entity.

Furthermore, in accordance with some embodiments of the present disclosure, when the trained NN model provides a prediction score above a preconfigured threshold the computer-implemented method may further comprise blocking a transaction of the new entity.

### BRIEF DESCRIPTION OF THE DRAWINGS

FIGS. 1A-1B schematically illustrate a high-level diagram of a system for training a Neural Network (NN) model for name screening based on a sanction list of fraud entities, in accordance with some embodiments of the present disclosure;

FIG. 2 is a high-level workflow of a computer-implemented method for training a Neural Network (NN) model for name screening based on a sanction list of fraud entities, in accordance with some embodiments of the present disclosure;

FIG. 3 is a workflow of training a Neural Network (NN) model for name screening based on a sanction list of fraud entities, in accordance with some embodiments of the present disclosure;

FIG. 4 is a workflow of prior art solution for watchlist filtering, in accordance with some embodiments of the present disclosure;

FIG. 5 is a workflow of triplet preparation based on a sanction list of fraud entities, in accordance with some embodiments of the present disclosure;

FIG. 6 illustrates embeddings formation, in accordance with some embodiments of the present disclosure;

FIG. 7 is an example of a list of feature ids for ML model training, in accordance with some embodiments of the present disclosure;

FIG. 8 shows an example of benchmark utilities running on a watchlist, in accordance with some embodiments of the present disclosure;

FIG. 9 is an example of a tuning log, in accordance with some embodiments of the present disclosure;

FIG. 10 is a high-level diagram of a Watchlist Filtering (WLX) system, in accordance with some embodiments of the present disclosure;

FIG. 11 is an example of bucketing of the watchlist entry into categories, in accordance with some embodiments of the present disclosure;

FIG. 12 is an example of a system for training a Neural Network (NN) model for name screening based on a sanction list of fraud entities, in accordance with some embodiments of the present disclosure;

FIG. 13 is an example of alerts screen, in accordance with some embodiments of the present disclosure;

FIG. 14 is an example of data structure of an entity, in accordance with some embodiments of the present disclosure;

FIG. 15 is an example of entity details in a sanction list of fraud entities, in accordance with some embodiments of the present disclosure;

FIG. 16 is an example of a tuning log of prior art solution for watchlist filtering used for training of the NN model, in accordance with some embodiments of the present disclosure;

FIG. 17 shows a confusion matrix of a trained NN mode, in accordance with some embodiments of the present disclosure;

FIG. 18 is a graph comparing total hits for investigation and suppressed hits, in accordance with some embodiments of the present disclosure; and

FIG. 19 shows user interface examples, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing.” “calculating,” “determining.” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

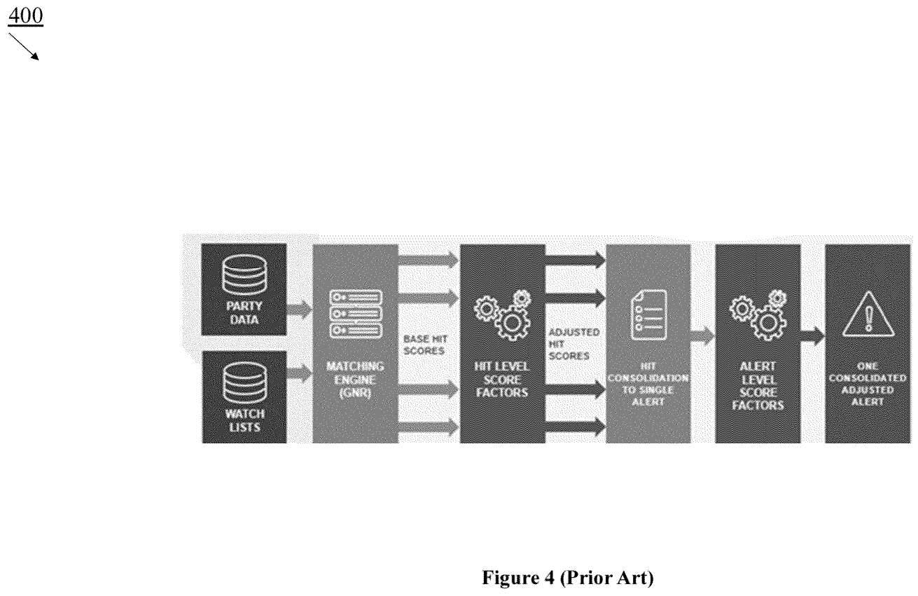

Current solution for watchlist filtering such as technical solution 400 in FIG. 4 is operated by providing the entity name and the sanction name to a matching engine, to yield a base hit score and then adjusting the base hit score based on other score factors, such as id, gender, birth country and alias.

Current solution for watchlist filtering such as technical solution 400 in FIG. 4 yields hits and alerts that depend on the quality of data provided by the user during the name screening, the matching engine, matching engine configuration, availability of score factors, and its correct tunning. If any of these are not configured correctly, many false hits may be received which are overhead for the users of the system in terms of time, effort, and cost.

Therefore, there is a need for a technical solution that will not depend on configuration expertise or on hit and trial tunning and manual intervention that result in a lot of false hits. The needed technical solution should not depend on human intervention and instead rely on a trained ML model, that may learn the pattern of data to provide correct hits.

Furthermore, each name in a sanction list of fraud entities appears only once in a certain spelling where in reality the name may have several variations of spellings, which might make it difficult to identify by a simple comparison during name screening. Accordingly, there is a need for a technical solution to train a Neural Network (NN) model for name screening based on a sanction list of fraud entities to identify a name in the sanction list of fraud entities when a different spelling variation of the name is introduced.

The term “fraud entity”, as used herein refers to a person or entities listed in a sanction list or a new fraud entity that is being screened.

The term ‘watchlist’, as used herein refers to a sanction list of fraud entities.

The term “hits” as used herein refers to multiple matches received for one input name.

The term “labeled data” as used herein refers to hits with label as true hit and false hit.

The terms “vector” and embeddings as used herein are interchangeable.

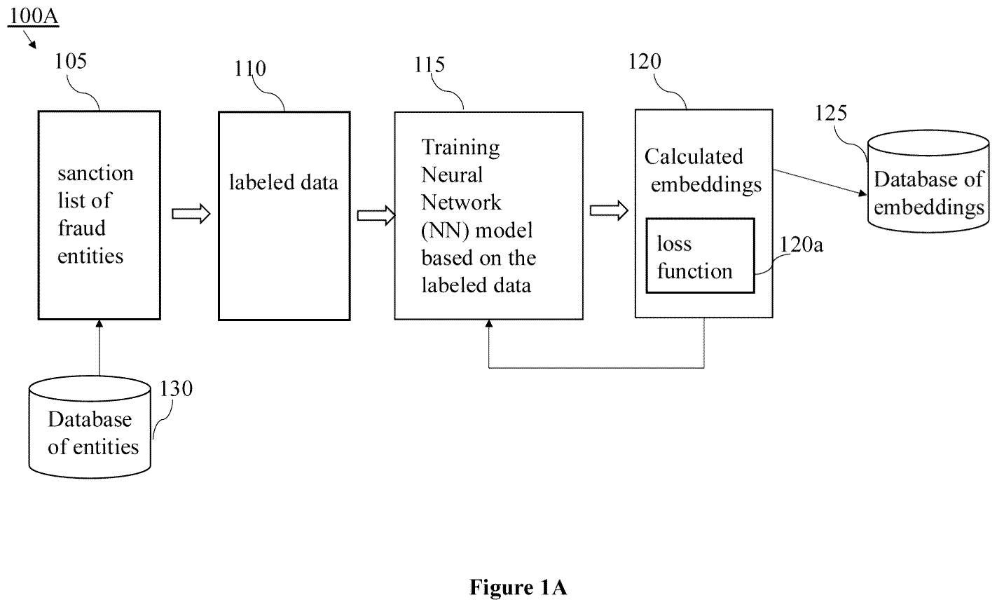

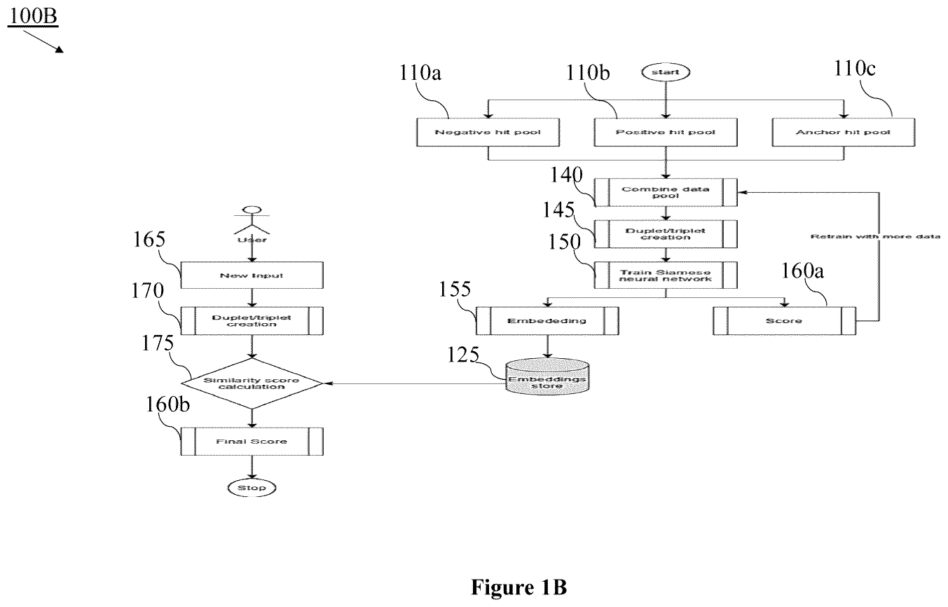

FIG. 1A schematically illustrates a high-level diagram of a system 100A for training a Neural Network (NN) model for name screening based on a sanction list of fraud entities, in accordance with some embodiments of the present disclosure.

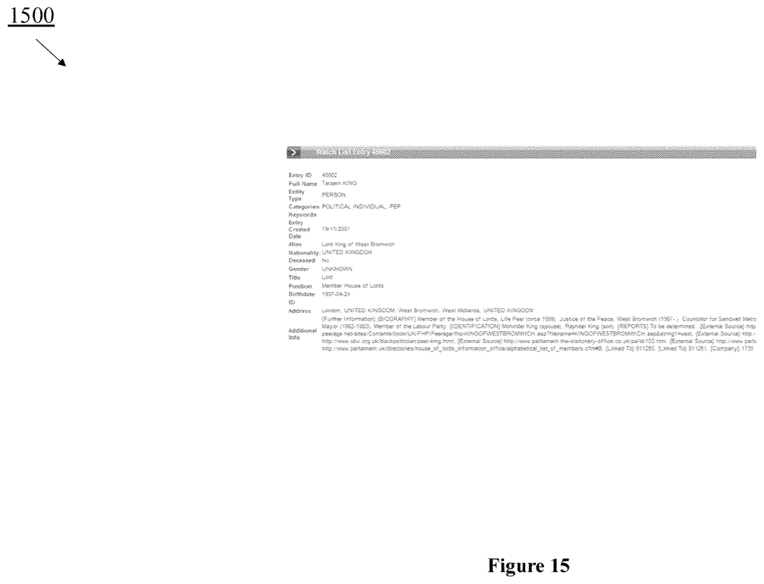

According to some embodiments of the present disclosure, a system, such as system 100A may prepare labeled data 110 based on a sanction list of fraud entities 105. The sanction list of fraud entities may be stored in a database of entities 130, and each entity in the database of entities 130 has a name and other attributes, for example, as shown in FIG. 15. The labeled data 110 may be used to train a Neural Network (NN) model for name screening 115. The training of the NN model may be based on the labeled data 110 to calculate embeddings of each entity name in the labeled data for each two or three sub-networks of the NN model.

According to some embodiments of the present disclosure, the embeddings may be forwarded to a loss function 120a to yield an indication as to necessity to adjust weights in the two or three sub-networks of the NN model. When the loss function indicates necessity to adjust weights in the two or three sub-networks of the NN model, for example, by a score 160a in FIG. 1B, then repeating the training of the NN model and forwarding again to the loss function 120a.

According to some embodiments of the present disclosure, during training of the NN model. the score 160a in FIG. 1B may be a probability score which may be mapped to ‘0’ or ‘1’ based on a threshold and then the name may be compared with the label of the hit to increase the accuracy of the NN model and the embedding at the end of the training.

According to some embodiments of the present disclosure, the indication as to necessity to adjust weights in the two or three sub-networks of the NN model may be a similarity result of the loss function which is below a preconfigured threshold.

According to some embodiments of the present disclosure, a triplet loss function may be based on formula I:

$$ℒ ( A , P , N ) = max ( {‖ f ( A ) - f ( P ) ‖}^{2} - {‖ f ( A ) - f ( N ) ‖}^{2} + α , 0 ) \qquad ( I )$$

Or formula II:

$${ℒ = max ( d ( a , p ) - d ( a , n ) + margin , 0 )}_{Triplet Loss Function} \qquad ( II )$$

whereby:
A is an entity labeled as anchor,
P is an entity labeled as positive,
N is an entity labeled as negative,
d(a,p) is a distance or similarity between anchor (a) and positive (p), and margin is a buffer to differentiate names which looks similar, but they are different.

According to some embodiments of the present disclosure, when the triplet loss function is based on formula I then the input of the triplet loss function is an entity labeled as anchor. The entity labeled as anchor may be compared to an entity that is labeled as positive and to an entity that is labeled as negative. The distance from the entity that is labeled as anchor to the entity that is labeled as positive may be minimized, and the distance from the entity that is labeled as anchor to the entity that is labeled as negative may be maximized. The a is a margin parameter which assists to distinguish names who look similar, but they are not the same.

According to some embodiments of the present disclosure, when the triplet loss function is based on formula II then the max function gives a max of an expression or ‘0’ which means that if the expression is negative, then the result of formula II is ‘0’.

According to some embodiments of the present disclosure, a duplet loss function may be a Sigmoid of absolute distance or similarity of two vectors.

$$D = Sigmoid ( ‖ d ( x 1 ) - d ( x 2 ) ‖ )$$

whereby:
d is a distance or similarity measure, and
x1 and x2 are name vector embeddings at the end of the NN model training.

According to some embodiments of the present disclosure, when the loss function 120a is based on a score which is a probability score, may not indicate necessity to adjust weights in the two or three sub-networks of the NN model then, the NN model is ready for operation.

When the loss function is giving a low score, it means that there is a necessity to adjust the weights in the sub-networks and the NN model requires more training until the score is higher.

The embeddings of each entity name may be stored in a database, such as database embeddings 125 and may be used by the trained NN model for name screening of a new entity by providing a prediction score for the new entity. The trained NN model operate name screening on a name of the new entity by generating an embedding of the new entity name and a similarity check model may compare it with the embeddings stored in the database of embeddings 125.

According to some embodiments of the present disclosure, the prediction score may be calculated by a model which may check similarity between embeddings of the new entity name generated by the trained NN model and the embeddings in the database of embeddings 125. The prediction score may indicate if the new entity is in the sanction list of fraud entities even when the name of the new entity has a different version of spelling of the name in the sanction list of fraud entities.

According to some embodiments of the present disclosure, when the similarity check model may provide a prediction score above a preconfigured threshold, an account of the new entity may be blocked.

According to some embodiments of the present disclosure, when the similarity check model may provide a prediction score above a preconfigured threshold a transaction that has been executes in an account related the new entity may be blocked.

According to some embodiments of the present disclosure, when the NN model has two sub-networks the NN model training may be based on combinations of entities labeled as ‘anchor’ and entities labeled as ‘negative’ or ‘positive’, and when the NN model has three sub-networks the NN model training may be based on combinations of entities labeled as ‘anchor’, entities labeled as ‘negative’, and entities labeled as ‘positive’.

According to some embodiments of the present disclosure, entities in the labeled data may be labeled as ‘anchor’ by collecting a first preconfigured percentage of the sanction list of fraud entities to yield a first sample and then operating a name screening model on the sanction list of fraud entities with an entity name from the first sample to mark generated hits as ‘anchor’. Entities in the labeled data may be labeled as ‘negative’ by removing a second sample of a second preconfigured percentage of the sanction list of fraud entities and then operating the name screening model on the sanction list of fraud entities with an entity name from the second sample to mark generated hits as ‘negative.

According to some embodiments of the present disclosure, entities in the labeled data may be labeled as ‘positive’ by collecting a third preconfigured percentage of the sanction list of fraud entities to yield a third sample. One or more algorithms may run on the third sample to generate variations of each entity name in the third sample and then operating name screening on the sanction list of fraud entities with an entity name from the third sample to mark generated hits as ‘positive’.

According to some embodiments of the present disclosure, the NN model may be a Siamese neural network.

FIG. 1B schematically illustrates a high-level diagram of a system 100B for training a Neural Network (NN) model for name screening based on a sanction list of fraud entities, in accordance with some embodiments of the present disclosure.

According to some embodiments of the present disclosure, a system, such as system 100B may implement NN model training. The training may include preparing labeled data based on a sanction list of fraud entities, such as sanction list of fraud entities 105 in FIG. 1A. The labeled data may be a combined data pool 140 from negative hit pool 110a, which maintain entities labeled as ‘negative, positive hit pool 110b, which maintain entities labeled as ‘positive and anchor hit pool 110c, which maintain entities labeled as ‘anchor.

According to some embodiments of the present disclosure, duplets, or triplets 145 for the training of the NN model, e.g., train Siamese neural network 150 may be created. The creating of duplets may include one or more combinations of entities which are labeled as ‘anchor’ and entities which are labeled as ‘positive or ‘negative. The creating of triplets may include one or more combinations of entities which are labeled as ‘anchor’ entities which are labeled as ‘positive and entities which are labeled as ‘negative.

According to some embodiments of the present disclosure, when the NN model has two sub-networks the NN model training may be based on duplets, i.e., combinations of entities labeled as ‘anchor’ and entities labeled as ‘negative’ or ‘positive’, and when the NN model has three sub-networks the NN model training may be based on triplets, i.e., combinations of entities labeled as ‘anchor’, entities labeled as ‘negative’, and entities labeled as ‘positive’.

According to some embodiments of the present disclosure, entities in the labeled data, e.g., in the anchor hit pool 110c, may be labeled as ‘anchor’ by collecting a first preconfigured percentage of the sanction list of fraud entities to yield a first sample and then a name screening model may be operated on the sanction list of fraud entities, such as sanction list of fraud entities 105 in FIG. 1A with an entity name from the first sample to mark generated hits as ‘anchor’.

According to some embodiments of the present disclosure, entities in the labeled data, e.g., in the negative hit pool 110a, may be labeled as ‘negative’ by removing a second sample of a second preconfigured percentage of the sanction list of fraud entities and then operating the name screening model on the sanction list of fraud entities, such as sanction list of fraud entities 105 in FIG. 1A with an entity name from the second sample to mark generated hits as ‘negative.

According to some embodiments of the present disclosure, entities in the labeled data are labeled as ‘positive’, e.g., in the positive hit pool 110b, by collecting a third preconfigured percentage of the sanction list of fraud entities to yield a third sample, and then running one or more algorithms on the third sample to generate variations of each entity name in the third sample and operating name screening on the sanction list of fraud entities with an entity name from the third sample to mark generated hits as ‘positive’.

According to some embodiments of the present disclosure, when a loss function that received calculated embeddings during the training of the NN model may not yield an indication as to necessity to adjust weights in the two or three sub-networks of the NN model, the calculated embeddings, e.g., embeddings 155 may be stored in a database of embeddings, such as embeddings store 125.

According to some embodiments of the present disclosure, the embeddings 155 of each entity name stored in the database of embeddings, such as embeddings store 125 may be used to operate name screening for a new entity 165 by the trained NN model by converting the new entity name into embedding and then using the embedding stored in the embeddings store 125 to operate a model to calculate a similarity score 175 to provide a final score which is a prediction score for the new entity 160b. The prediction score may indicate the possibility that the name or a variation of the name of the new entity is in the sanction list of fraud entities.

According to some embodiments of the present disclosure, a duplet or triplet creation 170 may be operated to get embedding for a name of a new entity instead of the trained NN model.

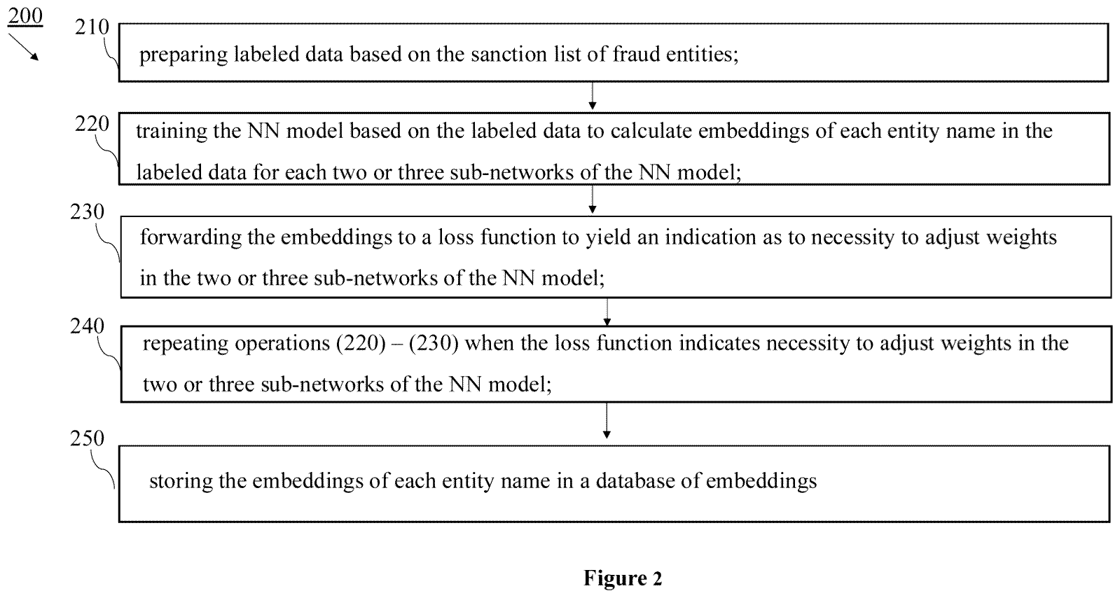

FIG. 2 is a high-level workflow of a computer-implemented method 200 for training a Neural Network (NN) model for name screening based on a sanction list of fraud entities, in accordance with some embodiments of the present disclosure.

According to some embodiments of the present disclosure, operation 210 comprising preparing labeled data based on the sanction list of fraud entities.

According to some embodiments of the present disclosure, operation 220 comprising training the NN model based on the labeled data to calculate embeddings of each entity name in the labeled data for each two or three sub-networks of the NN model.

According to some embodiments of the present disclosure, operation 230 comprising forwarding the embeddings to a loss function to yield an indication as to necessity to adjust weights in the two or three sub-networks of the NN model.

According to some embodiments of the present disclosure, operation 240 comprising repeating operation (220)-(230) when the loss function indicated necessity to adjust weights in the two or three sub-networks of the NN model.

According to some embodiments of the present disclosure, operation 250 comprising storing the embeddings of each entity name in a database of embeddings. The sanction list of fraud entities may be stored in a database of entities, and each entity in the database of entities has a name and other attributes, for example, as shown in FIG. 15.

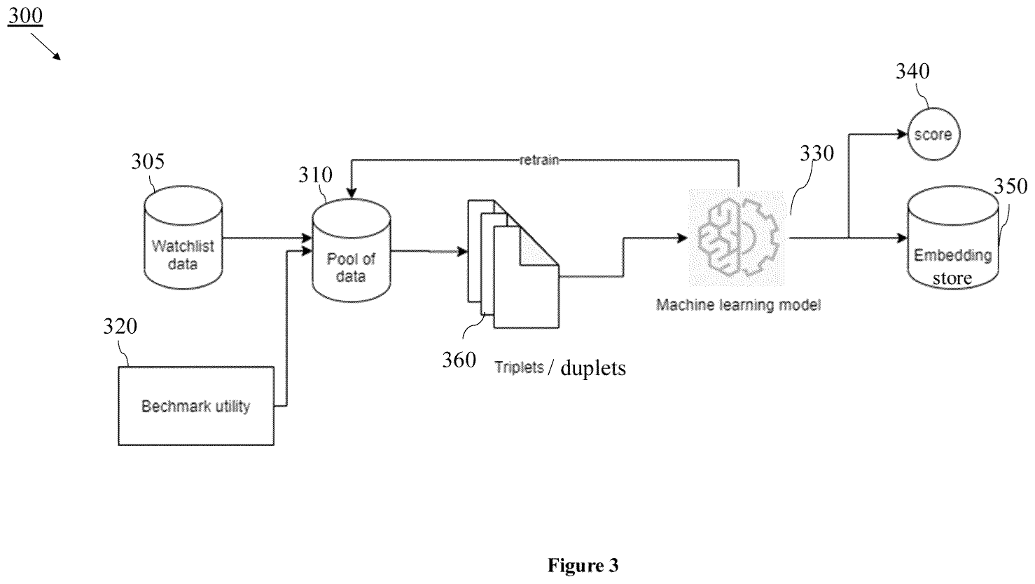

FIG. 3 is a workflow of training a Neural Network (NN) model for name screening based on a sanction list of fraud entities, in accordance with some embodiments of the present disclosure.

According to some embodiments of the present disclosure, for any Machine Learning (ML) solution, when data is not available for training of the ML model, alternate ways for training the ML model should be found. Accordingly, a portion of a watchlist data, such as the sanction list of fraud entities 105 in FIG. 1A, for example, 10% of the data, may be selected to run name screening on top of the watchlist data 305 and the results may be labeled as ‘anchor’ to yield a pool of anchor hits. The results may be labeled as ‘anchor’, since the names are available in both the selected portion from the watchlist data and the watchlist data 305. The results may be a pool of anchor hits, for example, such as anchor hit pool 110c in FIG. 1B. The yielded pool of anchor hits may be stored in a pool of data 310, such as labeled data 110 in FIG. 1A.

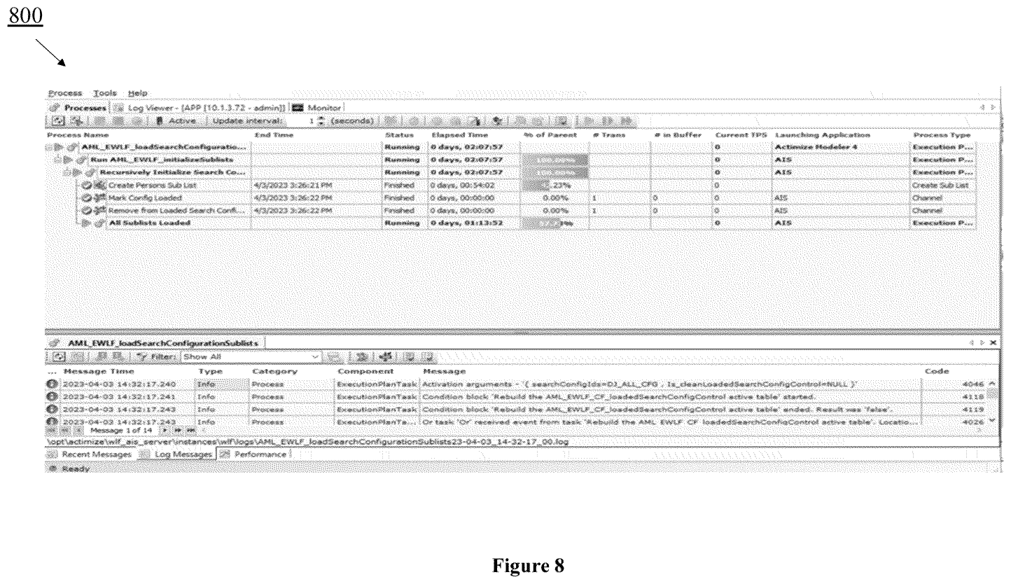

According to some embodiments of the present disclosure, benchmark utilities 320, for example, as shown in FIG. 8, may run on a selected portion of the sanction list of fraud entities 105 in FIG. 1A, for example, 10% of the data, to produce name variations of the names of the entities in the selected portion and then a name screening model may run on top of the watchlist data 305 to label the results as positive and to yield a pool of positive hits, for example, such as positive hit pool 110b in FIG. 1B, to be stored in the pool of data 310.

According to some embodiments of the present disclosure, benchmark utilities is a function which may accept a name and may output a preconfigured number of the name variations, e.g., 12 name variations. For example, when the name input is john Smith the output of the benchmark utilities would be Jonh smith, smith john, john smit.

According to some embodiments of the present disclosure, a selected portion of the sanction list of fraud entities 105 in FIG. 1A may be removed from the watchlist data 305 to label results as negative and to yield a pool of false positive hits, i.e., negative hit pool, such as negative bit pool 110a in FIG. 1B after running name screening on top of the watchlist data 305 without the removed portion, to be stored in the pool of data 310.

According to some embodiments of the present disclosure, the labeled data in the pool of data 310 may be forwarded as triplets or duplets of the entities in the pool of data 310 to a model, such as machine learning model 330, i.e., the NN model.

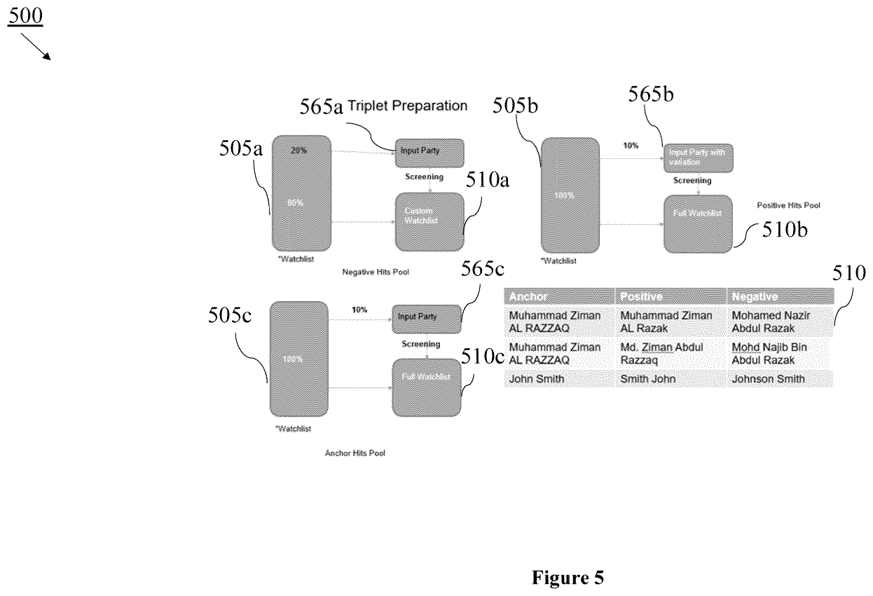

According to some embodiments of the present disclosure, for example, the NN model may be Siamese network, that requires data in the form of duplets and triplets form depending on the architecture. The duplets and triplets may be generated from combinations of labeled entities in the pool of data 310, as shown for example, in FIG. 5. Duplets may be generated from entities which are labeled as ‘anchor’ and entities which are labeled as ‘positive or ‘negative. Triplets may be generated from entities which are labeled as ‘anchor’, entities which are labeled as ‘positive and entities which are labeled as ‘negative.

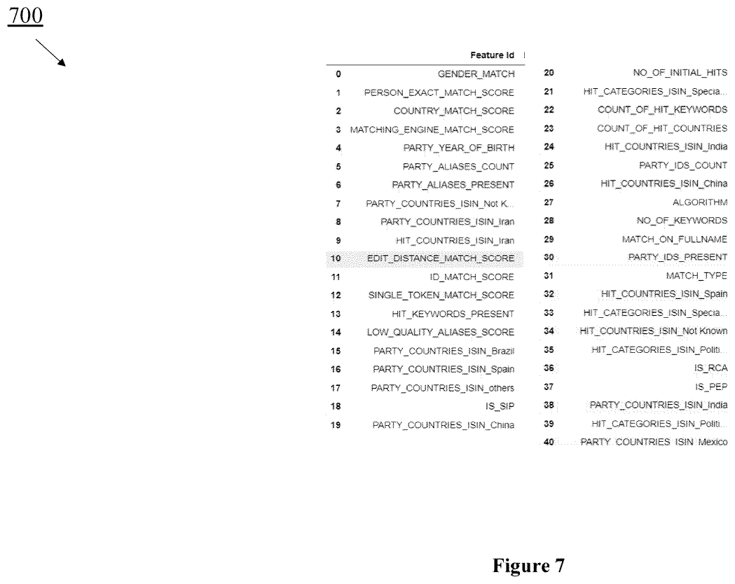

According to some embodiments of the present disclosure, the training of the NN model may be operated based on feature ids, such as, for example, the feature ids in the list of feature ids for ML model training in FIG. 7.

According to some embodiments of the present disclosure, features are needed for any NN model. The features may be demographic details like name match score, id match score, alias match score, country match score, is that party belongs to some sanction country yes or no. The match score may be generated based on the input and its comparison with sanction list entries.

According to some embodiments of the present disclosure, at the end of the training of the NN model, embeddings may be stored in embedding store 350. For every entity there may be a vector of 128 bit.

According to some embodiments of the present disclosure, the embeddings may be forwarded to a loss function that may yield an indication as to necessity to adjust weights in the two or three sub-networks of the NN model.

According to some embodiments of the present disclosure, during the training of the NN model, the NN model may yield a prediction score 340. The NN model may run in iterations and in each iteration, it may provide a score which may be consumed in the loss function to tune the parameters inside the NN model. The iterations may be stopped when the final score provided by the NN model, and the loss function calculated on top of it is very low, based on a preconfigured threshold.

FIG. 5 is a workflow of triplet preparation based on a sanction list of fraud entities 500, in accordance with some embodiments of the present disclosure.

According to some embodiments of the present disclosure, a portion of a watchlist data 505c, such as the sanction list of fraud entities 105 in FIG. 1A, for example, the portion may be 10% of the data 565c, may be selected to run name screening on top of the watchlist data 510c, i.e., watchlist data 505c and the results may be labeled as ‘anchor’ to yield a pool of anchor hits. The results may be labeled as ‘anchor’, because the names are available in both the selected portion from the watchlist data 565c and the watchlist data 510c. The results may be a pool of anchor hits, for example, such as anchor hit pool 110c in FIG. 1B which may be stored in a pool of data, such as labeled data 110 in FIG. 1A.

According to some embodiments of the present disclosure, benchmark utilities, for example, as shown in FIG. 8, may run on a selected portion of the watchlist 505b, for example, the portion may be 10% of the data, to produce name variations of the names of the entities in the selected portion 565b and then a name screening model may run on top of the watchlist data 510b, i.e., 505b to label the results as positive and to yield a pool of positive hits, for example, such as positive hit pool 110b in FIG. 1B, to be stored in the pool of data, such as labeled data 110 in FIG. 1A.

According to some embodiments of the present disclosure, a selected portion of the watchlist 505a, for example 20% data, may be removed from the watchlist data 505a to label results as negative and to yield a pool of false positive hits, i.e., negative hit pool, such as negative bit pool 110a in FIG. 1B after running a name screening model on top of the watchlist data 510a, where watchlist data 510a is a custom watchlist that doesn't include the removed portion.

According to some embodiments of the present disclosure, the labeled data in the pool of data, for example labeled data 510, may be forwarded as triplets or duplets of the entities in the pool of data 510 to a model, such as machine learning model 330 in FIG. 3 for training purposes.

According to some embodiments of the present disclosure, a triplet may be for example, ‘Muhammad Ziman’ which is labeled as ‘anchor’. ‘Muhammad Ziman’ which is labeled as ‘positive’ and Mohamed Nazir’ which is labeled as ‘negative’. A duplet may be for example, ‘Muhammad Ziman AL RAZZAQ’ which is labeled as ‘anchor’ and ‘Md. Ziman Abdul Razzaq’ which is labeled as ‘positive’. Alternatively, a duplet may be for example, ‘Muhammad Ziman AL RAZZAQ’ which is labeled as ‘anchor’ and ‘Mohd Najib Bin Abdul Razaq’ which is labeled as ‘negative’.

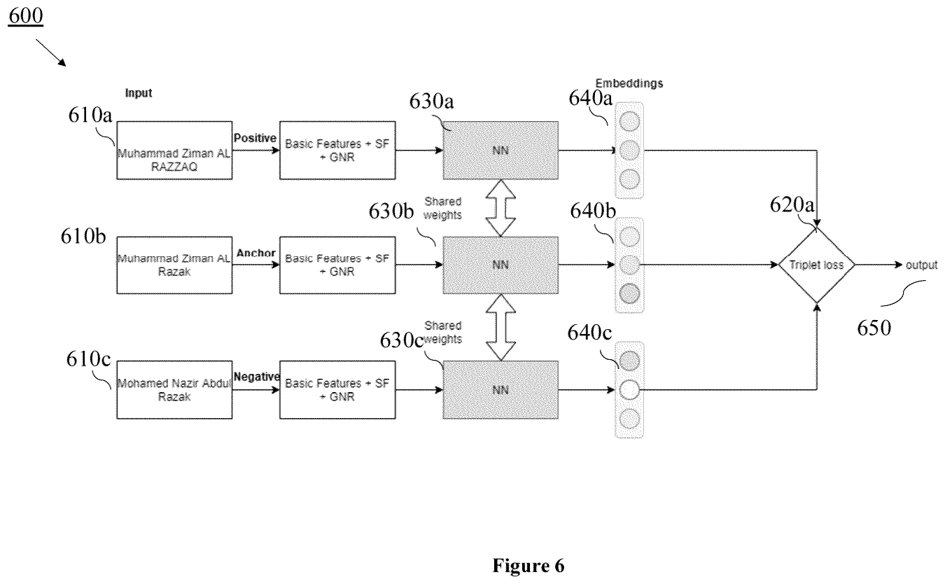

FIG. 6 illustrates embeddings formation, in accordance with some embodiments of the present disclosure.

According to some embodiments of the present disclosure, labeled data, such as labeled data 510 in FIG. 5, may be provided during training of a NN model that includes three sub-networks 630a-630c. The labeled data may be in a form of triplets. For example, Muhammad Ziman AL RAZZAQ' 610a which is labeled as ‘anchor’ and ‘Md. Ziman Abdul Razzaq’ 610b which is labeled as ‘positive’ and ‘Mohd Najib Bin Abdul Razaq’ 610c which is labeled as ‘negative’.

According to some embodiments of the present disclosure, the training of the NN model based on the labeled data may calculate embeddings 640a-640c from each sub-network. The calculated embeddings may be forwarded to a loss function, such as triplet loss function 620a to yield an indication 650 as to the necessity to adjust the weights in the sub-networks of the NN model.

According to some embodiments of the present disclosure, features are coming from three places. (i) a base demographic feature like party id, party alias, party place of birth, party type, (ii) score factors like gender match, id match alias match and (iii) features from current name recognition system. such as Global name recognition (GNR) of IBM® Application Programming Interface (API) which are internal features used for name matching only.

According to some embodiments of the present disclosure, a triplet loss function may be based on formula I:

$$ℒ ( A , P , N ) = max ( {‖ f ( A ) - f ( P ) ‖}^{2} - {‖ f ( A ) - f ( N ) ‖}^{2} + α , 0 )$$

FIG. 8 shows an example 800 of benchmark utilities running on a watchlist. in accordance with some embodiments of the present disclosure.

According to some embodiments of the present disclosure, example 800 shows benchmark utilities services running which may generate name variation and may be used in creation of triplets and duplets.

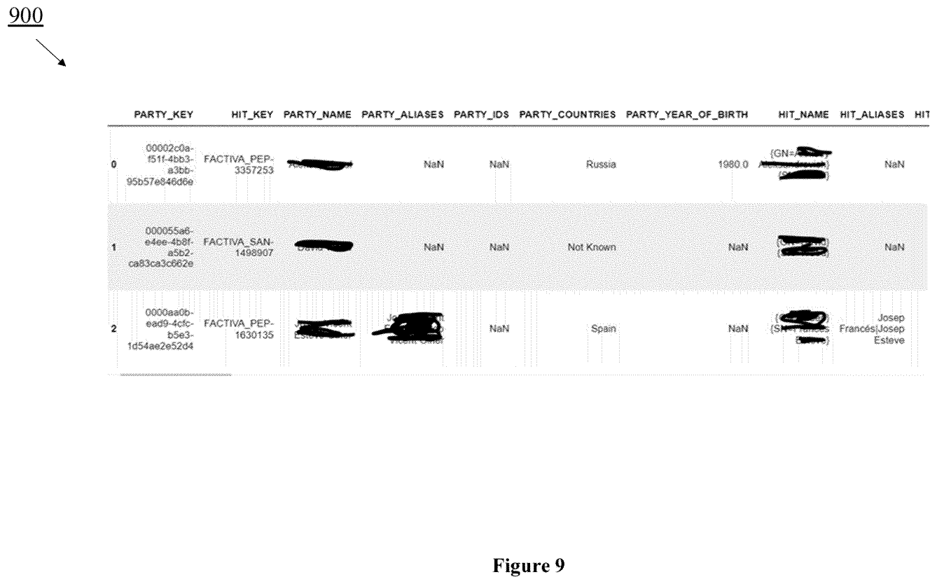

FIG. 9 is an example of a tuning log 900, in accordance with some embodiments of the present disclosure.

According to some embodiments of the present disclosure, the tuning log may provide all the attributes of the names.

According to some embodiments of the present disclosure, the name screening model may be operated by (i) providing the entity name and a sanction name to a matching engine, to yield a base hit score; and (ii) adjusting the base hit score based on other score factors.

According to some embodiments of the present disclosure, based on a match engine score and total hit score, hits may be labeled as true positive or false positives. For example, by comparing the match engine score to a threshold, e.g., (>=) ‘95’ and total hit score and alert is for example, greater than ‘130’ then it is ‘true hit’ otherwise it is ‘false hit’.

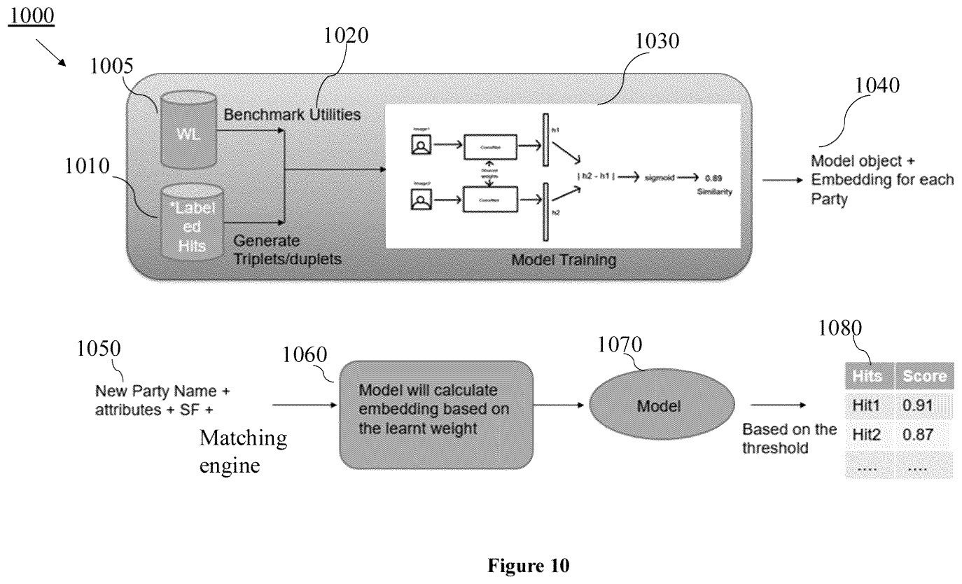

FIG. 10 is a high-level diagram of a Watchlist Filtering (WLX) system 1000, in accordance with some embodiments of the present disclosure.

According to some embodiments of the present disclosure, watchlist 1005, such as watchlist data 305 in FIG. 3, benchmark utilities 1020, such as benchmark utility 320 in FIG. 3 and labeled entities 1010, such as pool of data 310 in FIG. 3 may be used for training of the NN model.

According to some embodiments of the present disclosure, for example, during the model training 1030 a duplet training may be operated with one positive entity and one negative entity through the Siamese Neural Network. The Siamese network may provide embedding that may be compared for similarity between the embeddings using abs(H2-h2). On top of the comparison a Sigmoid function may be applied to convert the score to the range between ‘0’ and ‘1’. When a name of a positive entity and a name of a negative entity are the same the loss function output, e.g., score should be ‘0’ and when a name of a positive entity and a name of a negative entity are different the loss function output, e.g., score ‘1’. Meaning, the function, such as Sigmoid function may operate a standard scalar to the range of ‘0’ to ‘1’. When the value of the score is ‘1’ it indicates that there is a close match and when the value is ‘0’ it indicates that there is no match.

According to some embodiments of the present disclosure, the training of the NN model may result with an object of the trained NN model and embeddings for each entity of the sanction list of fraud entities that may be stored in a database, such as database of entities 130 in FIG. 1A.

According to some embodiments of the present disclosure, when the trained NN model is implemented in production environment, it may be operated for name screening of a new entity name. The new entity name may be of an entity that is operating a transaction or a new entity that came to open an account for future transactions. The new entity name and related attributes as well as Score Factors (SF) and matching engine score and features 1050 may be provided to the trained NN model 1060 to calculate embedding based on the learnt weights. The converted embedding of the new entity name may be forwarded to a model 1070 to calculate a score that indicates similarity between the calculated embedding of the new entity name and embeddings in the embeddings database.

According to some embodiments of the present disclosure, the calculated score may be compared with a preconfigured threshold to provide a prediction score as to the new entity is part of the sanction list of fraud entities.

According to some embodiments of the present disclosure, the provided prediction score may be higher than a preconfigured value which means that the entity is part of the sanction list, and an action should be taken. For example, an account or transaction of the new entity may be blocked.

According to some embodiments of the present disclosure, table 1080 is an example of multiple hits of a new party embedding matches with sanctioned list embedding. some of them are close match some of them are less close so we will keep only those whose score are greater than configured threshold.

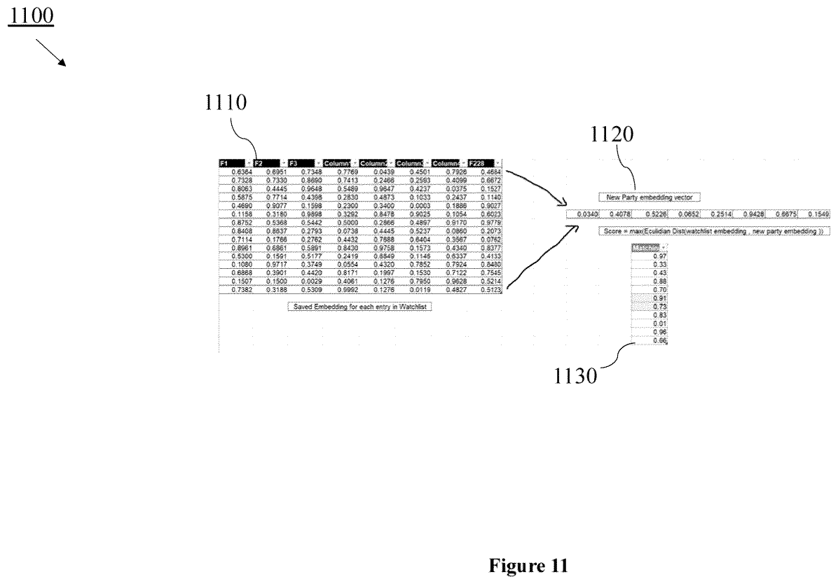

FIG. 11 is an example of bucketing of the watchlist entry into categories, in accordance with some embodiments of the present disclosure.

According to some embodiments of the present disclosure, a model, such as model 1070, in FIG. 10 may calculate a score that indicates similarity between the calculated embedding of the new entity name by a trained NN mode, for example embedding 1120, and embeddings in the embeddings database, such as, table 1110. The score may be calculated by the NN model by formula II:

score=max(Euclidian Dist(watchlist embedding, new entity embedding)) II

whereby:
watchlist embedding is an embedding of an entity in the database of entities.
new entity embedding is a calculated embedding of the new entity by the trained NN model.

According to some embodiments of the present disclosure, the score by formula II may be the maximum similarity, i.e., Euclidian distance, between the embedding of the new entity and an embedding in the database of entities from a list of scores 1130.

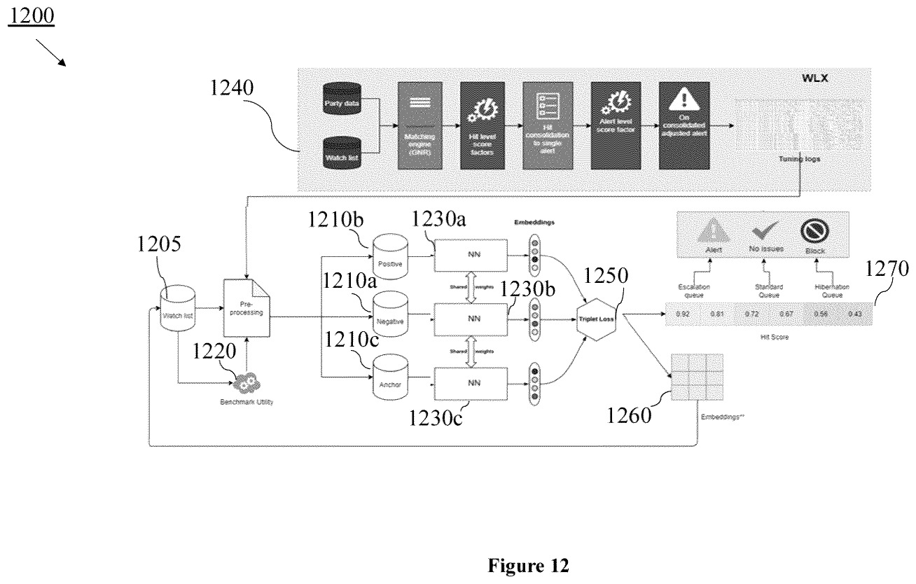

FIG. 12 is an example of a system 1200 for training a Neural Network (NN) model for name screening based on a sanction list of fraud entities, in accordance with some embodiments of the present disclosure.

According to some embodiments of the present disclosure, in a system, such as system 1200, names may be screened against the sanction list of fraud entities which may be maintained, internally or dependent externally, by a bank or a financial institution or any other organization that is obligated to prevent breaching of the sanction list.

According to some embodiments of the present disclosure, current name recognition system, such as Global name recognition (GNR) of IBM® Application Programming Interface (API) may be used in system 1240 to screen a name against all the names in a sanction lists maintained by the bank, to yield tuning logs, such as tuning logs 900 in FIG. 9. The tuning logs may be used to generate duplets and triplets for the NN model training.

According to some embodiments of the present disclosure, system 1240 may return hits and a corresponding bit score which may be used with applied factors to get final hit score. The final hit score is a maximum score from a multiple scores of hits received for one input name.

According to some embodiments of the present disclosure, during the training of the NN model data from a tuning log produces by current system 1240, such as FIG. 4, may be used for preprocessing of entities in the watchlist 1205, such as sanction list for fraud entities 105 in FIG. 1A, to generate duplets or triplets.

According to some embodiments of the present disclosure, the preprocessing may further include using benchmark utility 1220, such as benchmark utility 320 in FIG. 3, to generate ‘positive’ labeled embeddings, such as positive 1210b and such as positive hit pool 110b in FIG. 1B. of names in the watchlist 1205. The preprocessing may further include generating ‘anchor’ labeled embeddings, such as anchor 1210c and such as anchor hit pool 110c in FIG. 1B and negative hit pool, such as negative 1210a and such as 110a in FIG. 1B.

According to some embodiments of the present disclosure, the training of the NN model based on the labeled data e.g., duplets or triplets may be provided to the sub-networks of the NN model 1230a-1230c to calculate embeddings from each sub-network. The calculated embeddings may be forwarded to a loss function, such as triplet loss function 1250 to yield an indication as to the necessity to adjust the weights in the sub-networks of the NN model.

According to some embodiments of the present disclosure, table 1270 is an example of final results, e.g., multiple matches or hits of a comparison between an embedding of a name of a new entity and embeddings of entities stored in a database, such as database of embeddings 125 in FIG. 1A. These multiple hits may be classified into three categories based on the score provided for each by the trained NN model. The three categories may be ‘escalation’ ‘standard’ and ‘hibernation’. ‘Escalation’ means that a user should investigate those hits. ‘Standard’ depends on the capacity of the user for investigation and ‘hibernation’ is not much required for investigation

According to some embodiments of the present disclosure, over time the training and the implementation of the NN model may not require the operation of system 1240 and it may be removed.

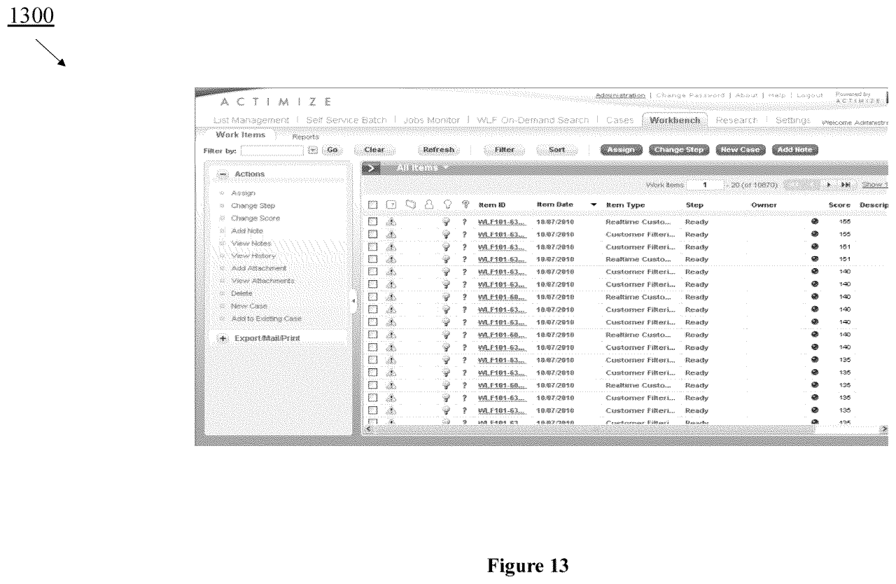

FIG. 13 is an example of alerts screen 1300, in accordance with some embodiments of the present disclosure.

Currently alerts yielded from current system, such as system 400 in FIG. 4 are not labeled but presented on a screen, such as alerts screen 1300.

According to some embodiments of the present disclosure, to label data that may be used for training of an NN model benchmark utilities and the approach of generating three pools of data, e.g., anchor, positive and negative as described in FIG. 1B may be implemented.

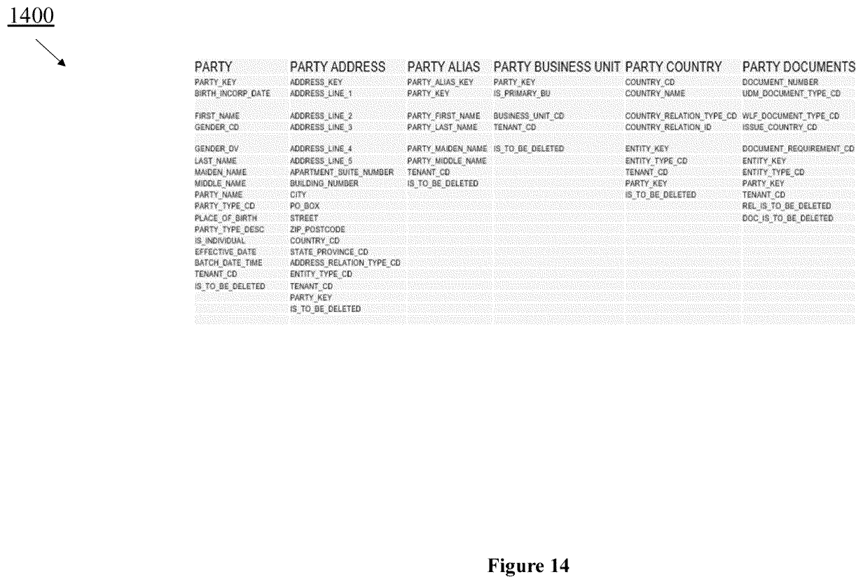

FIG. 14 is an example of data structure of an entity, in accordance with some embodiments of the present disclosure.

According to some embodiments of the present disclosure, the data structure of an entity that its name may be screened by a system such as system 100B or by a trained NN model by a method, such as computer implemented method 200 in FIG. 200 may include the entity details and other attributes, such as id, gender, birth country and alias.

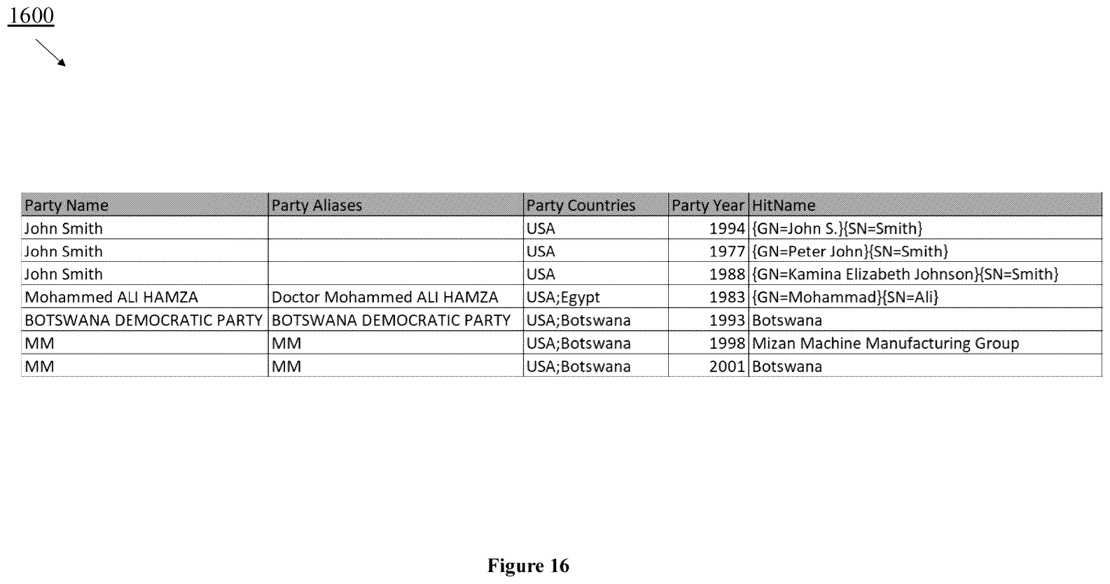

FIG. 16 is an example 1600 of a tuning log of prior art solution for watchlist filtering used for training of the NN model, in accordance with some embodiments of the present disclosure;

According to some embodiments of the present disclosure, the training of NN model based on the labeled data may also include attributes of the names taken from the tuning log of prior art solution for watchlist filtering, as shown in FIG. 4.

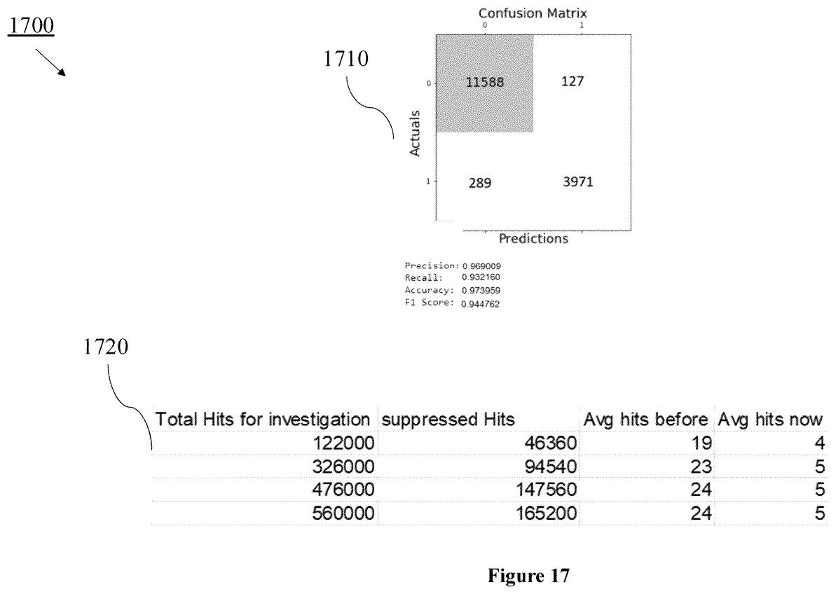

FIG. 17 shows a confusion matrix of a trained NN mode, in accordance with some embodiments of the present disclosure.

According to some embodiments of the present disclosure, the confusion matrix 1710 is shown to present the performance of a classification model, such as an NN model which has been trained by a method, such as computer-implemented method 200 in FIG. 2 and a system such as system 100B in FIG. 1B.

According to some embodiments of the present disclosure, table 1720 shows average hit for a total hits for investigation, where the average hits may be compared between hits by current system, such as system 400 in FIG. 4 and a system that is operating the trained NN model, such as system 100b, in FIG. 1B.

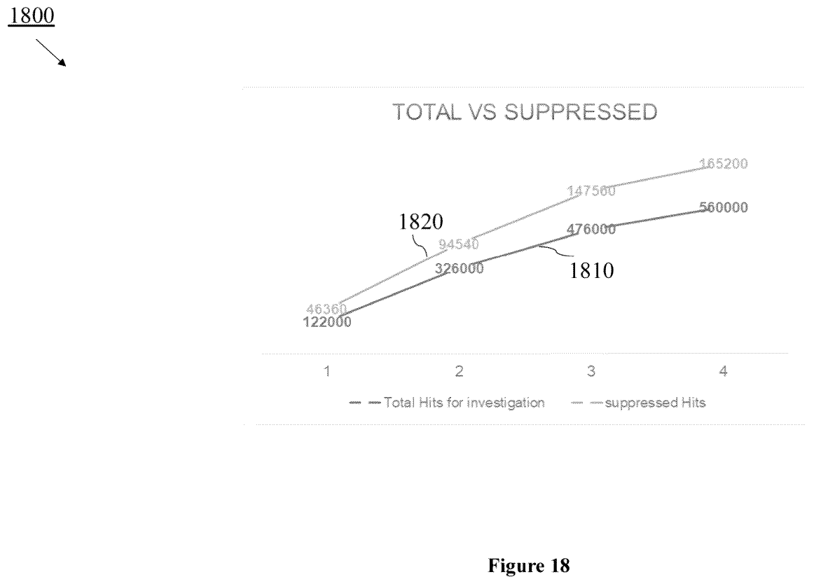

FIG. 18 is a graph comparing total hits for investigation and suppressed hits 1800, in accordance with some embodiments of the present disclosure.

According to some embodiments of the present disclosure, graph 1800 shows total hits 1810 vs. suppressed hits 1820 when the trained NN model is running.

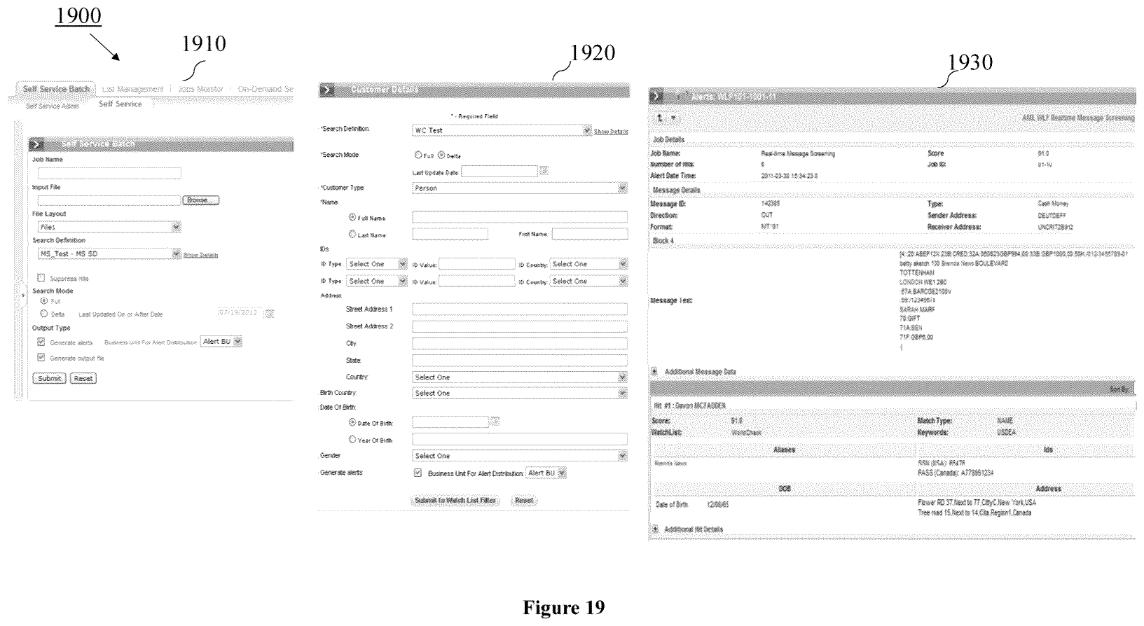

FIG. 19 shows user interface examples 1900, in accordance with some embodiments of the present disclosure.

According to some embodiments of the present disclosure, User Interface (UI) 1910 is an example of a batch UI where a user may be enabled to request a screen of a batch of entities. The user may collect all the new entities with the supporting attributes such as for example, id, alias countries, and gender and then upload it for screening. There may be other options for selection such as from which list to screen, and if an output or alerts are desired.

According to some embodiments of the present disclosure, UI 1920 is an example of a UI for screening one entity at a time. The UI 1920 may enable a user to enter details for watchlist filtering, as shown in FIG. 4 or screening by a system such as system 100A in FIG. 1A or system 100B in FIG. 1B.

According to some embodiments of the present disclosure, UI 1930 is an example of details of an alert generated by name screening by a system such as system 100A in FIG. 1A or system 100b in FIG. 1B

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computer-implemented method for training a Neural Network (NN) model for name screening based on a sanction list of fraud entities comprising:
(i) preparing labeled data based on the sanction list of fraud entities;
(ii) training the NN model based on the labeled data to calculate embeddings of each entity name in the labeled data for each two or three sub-networks of the NN model:
(iii) forwarding the embeddings to a loss function to yield an indication as to necessity to adjust weights in the two or three sub-networks of the NN model;
(iv) repeating operations (ii)-(iii) when the loss function indicates necessity to adjust weights in the two or three sub-networks of the NN model; and
(v) storing the embeddings of each entity name in a database of embeddings.
wherein said sanction list of fraud entities is stored in a database of entities, and
wherein each entity in the database of entities has a name and other attributes.

2. The computer-implemented method of claim 1, further comprising using the embedding of each entity name stored in the database of embeddings to operate name screening for a new entity by the trained NN model to provide a prediction score for the new entity.

3. The computer-implemented method of claim 1, wherein the labeled data includes entities labeled as ‘anchor’ for a first sub-network of the NN model and entities labeled as at least one of: ‘positive’ and ‘negative’ for a second and third sub-network of the NN model.

4. The computer-implemented method of claim 3, wherein when the NN model has two sub-networks the NN model training is based on combinations of entities labeled as ‘anchor’ and entities labeled as ‘negative’ or ‘positive’, and wherein when the NN model has three sub-networks the NN model training is based on combinations of entities labeled as ‘anchor’, entities labeled as ‘negative’, and entities labeled as ‘positive’.

5. The computer-implemented method of claim 3, wherein entities in the labeled data are labeled as ‘anchor’ by collecting a first preconfigured percentage of the sanction list of fraud entities to yield a first sample and then operating a name screening model on the sanction list of fraud entities with an entity name from the first sample to mark generated hits as ‘anchor’.
wherein entities in the labeled data are labeled as ‘negative’ by removing a second sample of a second preconfigured percentage of the sanction list of fraud entities and then operating the name screening model on the sanction list of fraud entities with an entity name from the second sample to mark generated hits as ‘negative, and
wherein entities in the labeled data are labeled as ‘positive’ by collecting a third preconfigured percentage of the sanction list of fraud entities to yield a third sample, running one or more algorithms on the third sample to generate variations of each entity name in the third sample and operating name screening on the sanction list of fraud entities with an entity name from the third sample to mark generated hits as ‘positive’.

6. The computer-implemented method of claim 5, wherein the name screening model is operated by:
(i) providing the entity name and the sanction name to a matching engine, to yield a base hit score; and
(ii) adjusting the base hit score based on other score factors.

7. The computer-implemented method of claim 1, wherein the NN model is a Siamese neural network.

8. The computer-implemented method of claim 1, wherein the indication as to necessity to adjust weights in the two or three sub-networks of the NN model is a similarity result of the loss function which is below a preconfigured threshold.

9. The computer-implemented method of claim 2, wherein when the trained NN model provides a prediction score above a preconfigured threshold blocking an account of the new entity.

10. The computer-implemented method of claim 2, wherein when the trained NN model provides a prediction score above a preconfigured threshold blocking a transaction of the new entity.
